(19) United States
(12) Patent Application Publication
(10) Pub. No.: US 2010/0012068 A1
(43) Pub. Date: Jan. 21, 2010

(54) Prioritizing Use Of Engine Cold Start Aids To mitigate Effect Of Weakened Battery Bank

(75) Inventors: Rogelio Rodriguez, Plainfield, IL (US); Tashmin Lopa, Naperville, IL (US)

Correspondence Address: INTERNATIONAL ENGINE INTELLECTUAL PROPERTY COMPANY, 4201 WINFIELD ROAD, P.O. BOX 1488, WARRENVILLE, IL, 60555, US

(73) Assignee: International Engine Intellectual Property Company , LLC, Warrenville, IL (US)

(21) Appl. No.: 12/497,185

(22) Filed: Jul. 2, 2009

Related U.S. Application Data
(60) Provisional application No. 61/078,126, filed on Jul. 3, 2008.

(51) Int. Cl. F02N 17/00

(52) U.S. Cl. 123/179.3

(57) ABSTRACT

A motor vehicle has an electric power supply that includes a battery bank (122), a compression ignition engine (100), different types of cold start aids (118, 120) that draw electric current from the power supply for aiding engine starting in cold ambient temperature, and a control (124) for monitoring voltage of the power supply while the cold start aids are drawing current from the battery bank and for interrupting the current to a lower priority one of the cold start aids, but not a higher priority one of the cold start aids, when monitored voltage falls below a threshold voltage.

### REFERENCE TO RELATED APPLICATION AND PRIORITY CLAIM

This application claims the priority of Provisional Patent Application No. 61/078,126, filed on 3 Jul. 2008, the entire content of which is incorporated herein by reference.

### TECHNICAL FIELD

This disclosure relates to internal combustion engines, especially diesel engines that have cold start aids, electrically operated glow plugs and intake air heaters in particular, for facilitating cold engine starting in cold weather. More specifically, the disclosure relates to a strategy that is effective when several cold start aids are being concurrently used for disabling a first cold start aid, but not a second one, should battery bank voltage in a vehicle that contains the engine drop enough to impair effectiveness of second cold start aid, thereby allowing the latter to continue operating at a somewhat higher voltage due to reduced current draw on the battery bank.

### BACKGROUND OF THE DISCLOSURE

Starting a cold diesel engine in a motor vehicle is difficult in some environmental conditions, such as when the engine has been soaked for an extended time in a cold ambient temperature. Various cold weather starting aids, such as glow plugs and block heaters, can facilitate engine starting.

A block heater typically is not operated by vehicle battery power, but rather by commercial AC electricity when plugged into a domestic or commercial AC receptacle.

A glow plug start aid system typically comprises one or more glow plugs associated with each combustion chamber, and some form of controller or control system that controls the delivery of electric current to the glow plugs from the vehicle battery bank. Glow plugs typically operate after the ignition switch has been turned on but before the engine is cranked, and they stay on only for a limited amount of time.

A glow plug lamp in an instrument panel typically serves as a wait-to-start indicator to inform the driver that the glow plugs have been turned on and that he/she should wait to crank the engine to allow the glow plugs time to be effective. Because the engine is not running as the glow plugs are starting to heat the engine cylinders, the engine-driven alternator is not keeping the battery bank recharged, and therefore the electricity for operating the glow plugs is being supplied exclusively by the battery bank. The glow plugs may continue to be energized for some amount of time after the engine has been cranked and commences running under its own power.

Certain diesel engines also have intake air heaters that are used in cold weather to pre-heat intake air during cold engine starting and ensuing initial running. An intake air heater serves to mitigate the generation of white smoke in engine exhaust until the engine becomes warmer and ceases exhausting white smoke. One type of intake air heater comprises an electric heating element that is controlled by a strategy that is embodied in the engine control system and utilizes data indicative of intake air temperature to control the flow of electric current to the heating element.

### SUMMARY OF THE DISCLOSURE

The applicants have observed that when starting a diesel engine in a motor vehicle is attempted under certain conditions, especially cold weather conditions, the engine may not start even though several different types of electric-operated cold start aids are being concurrently used. The applicants have identified a cause of such “no starts” as a weakened condition of the vehicle's battery bank on which multiple cold start aids are imposing a heavy current draw.

The simultaneous use of an intake air heater and glow plugs in a cold-soaked engine can create sufficiently large drain on a weakened battery bank that battery bank voltage drops to a level that noticeably impairs the effectiveness of one or both of these cold start aids and/or the ability of the engine cranking motor to develop enough torque for accelerating the engine to a high enough cranking speed (rpm) for enabling the engine to start and commence running under its own power.

This disclosure provides for priority of operation to be given to a first of two cold start aids over a second in such a situation so that increased battery bank voltage that results from discontinuance of battery bank current to the second cold start aid can increase the effectiveness of the first. Specifically, the applicants have determined that priority should be given to continuance of glow plug operation over continuance of operation of an intake air heater in such a situation.

The solution is embodied in a software strategy that monitors battery bank voltage and interrupts current to a lower priority cold start aid while allowing current to continue to a higher priority cold start aid when monitored voltage falls below some threshold voltage. The strategy also comprises a hysteresis function that after the strategy has interrupted the current to the lower priority cold start aid, is effective to terminate the interruption of current only if the monitored voltage rises above a voltage that is greater than the threshold voltage.

The claimed subject matter relates to a motor vehicle comprising an electric power supply that includes a battery bank, a compression ignition engine disposed within the engine compartment, and two different types of cold start aid that draw electric current from the power supply for aiding engine starting in cold ambient temperature.

A control monitors voltage of the power supply while both start aids are drawing current from the battery bank and interrupts the current to a lower priority one of the two different types of cold start aids, but not the higher priority one, when monitored voltage falls below some threshold voltage.

The claimed subject matter also relates to a method for mitigating battery bank voltage drop when different types of cold start aid are operating to aid starting of a compression ignition engine in cold ambient temperature by drawing electric current from the battery bank when battery bank voltage drops below some threshold.

The method comprises monitoring voltage of the battery bank and interrupting current to a lower priority one of the cold start aids, but not a higher priority one, when monitored voltage falls below the threshold voltage.

The claimed subject matter further relates to a motor vehicle comprising a battery bank, a compression ignition engine, an electric cranking motor that operates to crank the engine by drawing electric current from the battery bank, multiple cold start aids that operate by drawing electric current from the battery bank to pre-heat the engine in cold ambient temperature prior to operation of the cranking motor, and a control for monitoring voltage of the battery bank while the cold start aids are drawing current from the battery bank prior to operation of the cranking motor and for interrupting current to a cold start aid when the monitored voltage falls to some voltage that is greater than that at which the ability of the cranking motor to accelerate the engine to a cranking speed high enough to enable the engine to start and commence running under its own power would begin to become impaired.

The claimed subject matter still further relates to a method for preventing state-of-charge of a battery bank in a motor vehicle from being depleted by cold start aids that concurrently draw electric current from the battery bank to pre-heat a compression ignition engine in cold ambient temperature prior to engine cranking by an electric cranking motor that, when operated also draws electric current from the battery bank, to an extent that would begin to impair the ability of the cranking motor to accelerate the engine to a cranking speed high enough to enable the engine to start and commence running under its own power.

The method comprises monitoring voltage of the battery bank and interrupting current to a cold start aid when the monitored voltage falls to some voltage that is greater than that at which the ability of the cranking motor to accelerate the engine to a cranking speed high enough to enable the engine to start and commence running under its own power would begin to become impaired.

The foregoing summary, accompanied by further detail of the disclosure, will be presented in the Detailed Description below with reference to the following drawings that are part of this disclosure.

### BRIEF DESCRIPTION OF THE DRAWINGS

FIG. 1 is a somewhat schematic side elevation view of a diesel engine showing elements relevant to the present disclosure.

FIG. 2 is a diagram of a portion of an exemplary embodiment of software strategy in a control associated with the engine.

### DETAILED DESCRIPTION

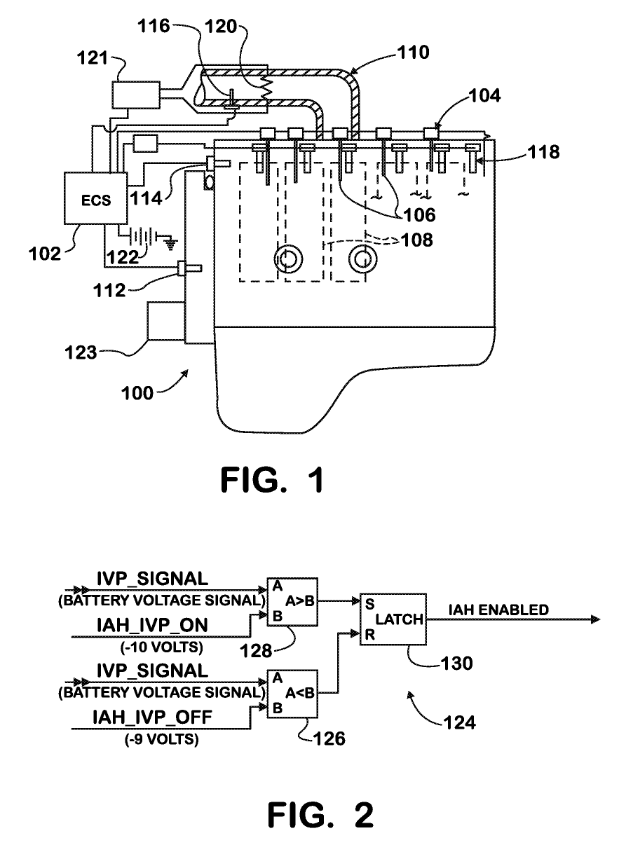

A diesel engine 100, like the one shown in FIG. 1, comprises an engine control system (ECS) 102 that comprises one or more processors that control various systems and devices, one of which is a fuel injection system 104 controlled by a fuel control strategy. Fuel injection system 104 comprises fuel injectors 106 that inject fuel into engine cylinders 108 where the injected fuel combusts to power the engine. Charge air enters cylinders 108 through an air intake system 110 to support combustion.

Measurement of various temperatures related to operation of engine 100 are performed by various sensors such as a coolant temperature sensor 112 associated with the coolant system at a suitable location and an oil temperature sensor 114 associated with the lubrication system at a suitable location. In the case of air intake system 110, an intake air temperature sensor 116 is disposed at a suitable location in the intake system to measure temperature. The three sensors provide coolant temperature data, oil temperature data, and intake air temperature data respectively to ECS 102.

Because a cold diesel engine is typically pre-heated to facilitate starting, especially if the engine has been soaked in cold ambient conditions, FIG. 1 shows both a glow plug heater system 118 and an intake air heater 120. The latter is associated with intake system 110 and is enabled by a strategy embodied in control system 102. Actual operation of heater 120, when enabled, occurs when a relay 121 is operated closed by ECS 102 to connect a battery bank 122 in the vehicle's electrical system to the heater so that electricity can flow through heater 120 and create heat that is transferred to air in intake system 110. After pre-heating, engine 100 is cranked by operating an electric cranking motor 123 that also draws current from battery bank 122.

FIG. 2 shows an example of a strategy 124 that is embodied in ECS 102 for mitigating the effect of decreased battery bank voltage on one or more electrically operated cold start aids and/or the ability of cranking motor 123 to develop sufficient torque for accelerating engine 100 to a cranking speed high enough for enabling it to start and commence running under its own power when battery bank 122, for whatever reason, is in a weakened condition.

The strategy comprises two comparison functions 126, 128 and a latch function 130. ESC 102 monitors the output voltage of battery bank 122 in any suitably appropriate way such as by reading it on a data link in the vehicle electrical system as a parameter designated in FIG. 2 as IVP_Signal.

Parameter IVP_Signal is one of two inputs to each comparison function 126, 128. The other input to comparison function 128 is a parameter IAH_IVP_ON. The other input to comparison function 126 is a parameter IAH_IVP_OFF.

The output of comparison function 126 is an input to a reset input of latch function 130. The output of comparison function 128 is an input to a set input of latch function 130. When latch function 130 is latched in the set state, the value of a parameter provided at its output and designated IAH Enabled, enables current flow to intake air heater 120. When latch function 130 is latched in the reset state, the value of parameter IAH Enabled unenables current flow to intake air heater 120.

When intake air heater 120 has been commanded to operate in aid of engine starting by a command input, the state of latch function 130 determines whether or not current is allowed to flow to the heater.

The value for parameter IAH_IVP_OFF corresponds to a battery bank voltage below which it has been determined that current to intake air heater 120 should be discontinued. The value for parameter IAH_IVP_ON corresponds to a battery bank voltage above which it has been determined that current to intake air heater 120 should be restored.

As long as the voltage of battery bank 122 exceeds the value corresponding to parameter IAH_IVP_ON, a typical value being approximately 10 volts in a nominal 12 volt electrical system, then comparison function 128 keeps latch function 130 in the reset state, allowing current to flow to intake air heater 120.

Should the voltage of battery bank 122 begin dropping and fall below the value corresponding to parameter IAH_IVP_ON, the output of comparison function 128 that had been applying a set signal to the set input of latch function 130 disappears. Latch function 130 will continue latched in the set state until a reset signal is applied to its reset input. Consequently, as long as battery bank voltage remains greater than the value corresponding to parameter IAH_IVP_OFF, latch function 130 remains latched, allowing current flow to intake air heater 120 to continue.

Should the voltage of battery bank 122 drop further and fall below the value corresponding to parameter IAH_IVP_OFF, the output of comparison function 126 applies a reset signal to the reset input of latch function 130, causing IAH Enabled to now unenable current flow to intake air heater 120.

With both intake air heater 120 and glow plug heater system 118 drawing current from battery bank 122 at the time that latch function is reset, the unenabling of the intake air heater causes current flow to the intake air heater to stop. The reduced current drain on the battery bank allows battery bank voltage to rise and consequently increase the power input to the glow plug heater system at least temporarily depending on the condition of the battery bank and on when the engine is actually cranked in an attempt to start it.

Depending on the particular engine and electrical system, operation of the glow plugs may also be interrupted while the engine is being cranked. Once the engine starts and begins to operate the alternator, recharging of the battery bank would be expected to begin restoring battery bank voltage toward nominal system voltage, such as 12 volts for example. Once parameter IVP_Signal rises above the value of parameter IAH_IVP_ON, comparison function 128 sets latch function 130 to once again enable the intake air heater. If the command to operate the intake air heater is still in effect, the intake air heater will begin to once again draw current from the battery bank.

The voltage differential represented by the difference between the voltage represented by parameter IAH_IVP_ON and the voltage represented by parameter IAH_IVP_OFF, as applied to the disclosed strategy, is sufficiently large (about one volt in the disclosed example) to provide a hysteresis function in the ON-OFF characteristic of the strategy that precludes the likelihood of frequent switching between on and off that might impose extra stress on the electrical system. The voltage/heating characteristic of the glow plugs and/or operating characteristic of cranking motor 123 may be factors for selecting a suitable value for parameter IAH_IVP_OFF. One example could be selecting a value for parameter IAH_IVP_OFF greater than that at which the ability of cranking motor 123 to accelerate engine 100 to a cranking speed high enough to enable the engine to start and commence running under its own power would begin to become impaired.

What is claimed is:

1. A motor vehicle comprising:
an electric power supply that includes a battery bank;
a compression ignition engine;
different types of cold start aids that draw electric current from the power supply for aiding engine starting in cold ambient temperature;
and a control for monitoring voltage of the power supply while the cold start aids are drawing current from the battery bank and for interrupting the current to a lower priority one of the cold start aids, but not a higher priority one of the cold start aids, when monitored voltage falls below a threshold voltage.

2. A motor vehicle as set forth in claim 1 wherein after the control has interrupted the current to the lower priority one of the cold start aids, the control is effective to terminate the interruption of current to the lower priority one of the cold start aids when the monitored voltage rises above the threshold voltage.

3. A motor vehicle as set forth in claim 2 wherein the control further comprises a hysteresis function that after the control has interrupted the current to the lower priority one of the cold start aids, is effective to terminate the interruption of current to the lower priority one of the cold start aids when the monitored voltage rises above a voltage that is greater than the threshold voltage.

4. A motor vehicle as set forth in claim 1 wherein the lower priority one of the cold start aids comprises an intake air heater for heating air in an air intake of the engine, and the higher priority one of the cold start aids comprises a glow plug system for heating engine cylinders.

5. A method for preventing different types of cold start aids that operate concurrently to aid starting of a compression ignition engine in cold ambient temperature by concurrently drawing electric current from a power supply comprising a battery bank from depleting battery bank charge to an extent that causes battery bank voltage to drop below a threshold voltage, the method comprising:
monitoring voltage of the battery bank and interrupting current to a lower priority one of the cold start aids, but not a higher priority one, when monitored voltage falls below the threshold voltage.

6. A method as set forth in claim 5 including, after the step of interrupting current to the lower priority one of the cold start aids, the further step of terminating the interruption of current to the lower priority one of the cold start aids when the monitored voltage rises above the threshold voltage.

7. A method as set forth in claim 5 including, after the step of interrupting current to the lower priority one of the cold start aids, the further step of terminating the interruption of current to the lower priority one of the cold start aids if the monitored voltage rises a voltage that is greater than the threshold voltage.

8. A method as set forth in claim 5 wherein the step of interrupting current to the lower priority one of the cold start aids, but not the higher priority one, when monitored voltage falls below the threshold voltage comprises interrupting current to an intake air heater, but not to cylinder glow plugs, when monitored voltage falls below the threshold voltage.

9. A motor vehicle comprising:
a battery bank;
a compression ignition engine;
an electric cranking motor that operates to crank the engine by drawing electric current from the battery bank;
multiple cold start aids that operate by drawing electric current from the battery bank to pre-heat the engine in cold ambient temperature prior to operation of the cranking motor;
and a control for monitoring voltage of the battery bank while the cold start aids are drawing current from the battery bank prior to operation of the cranking motor and for interrupting current to a cold start aid when the monitored voltage falls to some voltage that is greater than that at which the ability of the cranking motor to accelerate the engine to a cranking speed high enough to enable the engine to start and commence running under its own power would begin to become impaired.

10. A motor vehicle as set forth in claim 9 wherein the cold start aid to which the control interrupts current comprises an intake air heater.

11. A method for preventing state-of-charge of a battery bank in a motor vehicle from being depleted by cold start aids that concurrently draw electric current from the battery bank to pre-heat a compression ignition engine in cold ambient temperature prior to engine cranking by an electric cranking motor that, when operated also draws electric current from the battery bank, to an extent that would begin to impair the ability of the cranking motor to accelerate the engine to a cranking speed high enough to enable the engine to start and commence running under its own power, the method comprising:
monitoring voltage of the battery bank and interrupting current to a cold start aid when the monitored voltage falls to some voltage that is greater than that at which the ability of the cranking motor to accelerate the engine to a cranking speed high enough to enable the engine to start and commence running under its own power would begin to become impaired.

12. A method as set forth in claim 11 wherein the step of interrupting current to a cold start aid comprises interrupting current to an intake air heater.
